(19) United States
(12) Patent Application Publication
(10) Pub. No.: US 2018/0231968 A1
(43) Pub. Date: Aug. 16, 2018

(54) MANAGEMENT TARGET OPERATION SUPPORT DEVICE, MANAGEMENT TARGET OPERATION SUPPORT METHOD, AND PROGRAM THEREFOR

(71) Applicant: MITSUBISHI HITACHI POWER SYSTEMS, LTD., Kanagawa (JP)

(72) Inventors: Akihisa ENDO, Yokohama-shi (JP); Toru TANAKA, Yokohama-shi (JP)

(21) Appl. No.: 15/513,800

(22) PCT Filed: Sep. 25, 2015
(86) PCT No.: PCT/JP2015/077121

§ 371 Date: Mar. 23, 2017

(30) Foreign Application Priority Data
Oct. 3, 2014 (JP) 2014-205074

(51) Int. Cl. G05B 23/02; F01D 21/10; F01D 21/14; F01D 21/00

(52) U.S. Cl. CPC G05B 23/0235; F01D 21/10; F01D 21/14; F05D 2220/32; F01D 21/003; F05D 2260/80; G05B 23/0272

(57) ABSTRACT

An operation status of a management target device is calculated based on acquired sensing information of the management target device. An operation status level indicated by the calculation result of the operation status is compared with a plurality of threshold values for distinguishing the operation status level. Support information of the management target device corresponding to the operation status level is output based on the comparison of the operation status level with the threshold values.

### TECHNICAL FIELD

The present invention relates to a management target operation support device, a management target operation support method, and a program therefor.

Priority is claimed on Japanese Patent Application No. 2014-205074, filed Oct. 3, 2014, the content of which is incorporated herein by reference.

### BACKGROUND ART

After delivering a manufactured device to a client, a manufacturer ascertains an operation status of the device which is operated by the client after delivery and then puts it to use to support the device. For example, Patent Document 1 discloses a technique of acquiring information on an operation status of a gas turbine which is an example of a target device and diagnosing the performance of the gas turbine.

### PRIOR ART DOCUMENTS

### Patent Documents

[Patent Document 1] Japanese Unexamined Patent Application, First Publication No. 2006-57595

### SUMMARY OF THE INVENTION

### Problem to be Solved by the Invention

A manufacturer having delivered a manufactured device to a client as described above needs to further improve a service of supporting the device.

Therefore, an object of the present invention is to provide a management target operation support device, a management target operation support method, and a program therefor that can solve the above-mentioned problem.

### Means for Solving the Problem

According to a first aspect of the present invention, a management target operation support device includes: an operation status calculating unit configured to calculate an operation status of a management target device based on acquired sensing information of the management target device; a calculation result comparing unit configured to compare an operation status level indicated by the calculation result of the operation status with a plurality of threshold values for distinguishing the operation status level; and a support information output unit configured to output support information of the management target device corresponding to the operation status level based on the comparison of the operation status level with the threshold values.

In the above-described management target operation support device, the support information output unit may determine the support information to be output based on a cost corresponding to the support information and an affordable cost of an operator who operates the management target device.

In the above-described management target operation support device, when the support information is information for prompting replacement of a part of the management target device and it is determined that the part is a part which needs to be newly manufactured, the support information output unit may change the support information to be output based on a manufacturing time period of the part and maintenance time information determined in advance for the management target device.

In the above-mentioned management target operation support device, the support information output unit may transmit the support information to a terminal of an operator who operates the management target device when the level indicates a set low level, and the support information output unit may transmit the support information to a terminal of a manufacturer who has manufactured the management target device when the operation status level is not the set low level.

According to a second aspect of the present invention, a management target operation support method includes: calculating an operation status of a management target device based on acquired sensing information of the management target device; comparing an operation status level indicated by the calculation result of the operation status with a plurality of threshold values for distinguishing the operation status level; and outputting support information of the management target device corresponding to the operation status level based on the comparison of the operation status level with the threshold values.

According to a third aspect of the present invention, a program causes a computer of a management target operation support device to execute: calculating an operation status of a management target device based on acquired sensing information of the management target device; comparing an operation status level indicated by the calculation result of the operation status with a plurality of threshold values for distinguishing the operation status level; and outputting support information of the management target device corresponding to the operation status level based on the comparison of the operation status level with the threshold values.

### Effect of the Invention

According to the present invention, it is possible to improve a service of supporting a device serves as an operation target.

### BRIEF DESCRIPTION OF THE DRAWINGS

FIG. 1 is a diagram illustrating a configuration of a support system including a management target operation support device according to an embodiment of the present invention.

FIG. 2 is a functional block diagram of the management target operation support device according to the embodiment of the present invention.

FIG. 3 is a first diagram illustrating a processing flow of the management target operation support device according to the embodiment of the present invention.

FIG. 4 is a second diagram illustrating a processing flow of the management target operation support device according to the embodiment of the present invention.

FIG. 5 is a first diagram schematically illustrating a process of specifying support information according to the embodiment of the present invention.

FIG. 6 is a second diagram schematically illustrating a process of specifying support information according to the embodiment of the present invention.

### EMBODIMENTS FOR CARRYING OUT THE INVENTION

Hereinafter, a management target operation support device according to an embodiment of the present invention will be described.

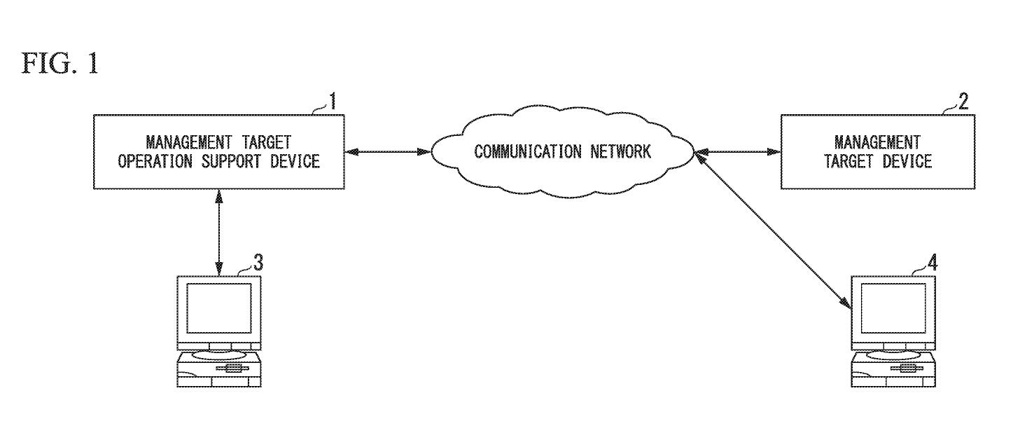

FIG. 1 is a diagram illustrating a configuration of a support system including a management target operation support device according to an embodiment of the present invention.

FIG. 1 illustrates a management target operation support device 1 (hereinafter referred to as a support device 1).

FIG. 1 illustrates a management target device 2, a manufacturer-side terminal 3 (hereinafter referred to as a first terminal 3), and an operator-side terminal 4 (hereinafter referred to as a second terminal 4).

As illustrated in FIG. 1, the management target operation support device 1 is connected to the management target device 2 and the second terminal 4 via a communication network and communicates therewith. The support device 1 is connected to the first terminal 3 and communicates with the first terminal. The support system including the support device 1 may be a system which is connected to the first terminal 3 via the communication network illustrated in FIG. 1 as well as a system which is directly connected to the first terminal as illustrated in FIG. 1.

In this embodiment, the support device 1 calculates an operation status of the management target device 2 on the basis of acquired sensing information of the management target device 2. The support device 1 compares the calculation result of the operation status with a plurality of threshold values for distinguishing an operation status level. The support device 1 performs a process of outputting support information of the management target device 2 corresponding to the operation status level to the first terminal 3 or the second terminal 4 on the basis of the operation status level specified by the calculation result of the operation status. In this embodiment, the management target device 2 is, for example, a gas turbine device. However, the management target device 2 may be conceived to be various devices. For example, the management target device 2 may be a vehicle such as an automobile, a construction vehicle, or a train or may be a plant as a whole. Alternatively, the management target device 2 may be a certain manufacturing device.

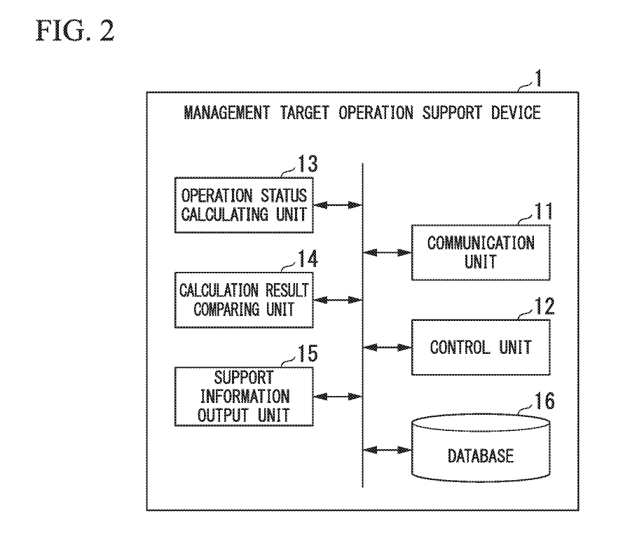

FIG. 2 is a functional block diagram of the support device 1.

As illustrated in FIG. 2, the support device 1 has functions of a communication unit 11, a control unit 12, an operation status calculating unit 13, a calculation result comparing unit 14, and a support information output unit 15. The functions are installed in the support device 1 by causing a central processing unit (CPU) in a computer of the support device 1 to execute an application program. The support device 1 includes a database 16. The support device 1 includes a CPU, a memory, a network interface card, and a hard disk drive (HDD) as hardware. Since these are general techniques, details thereof will not be described for the purpose of convenience of explanation.

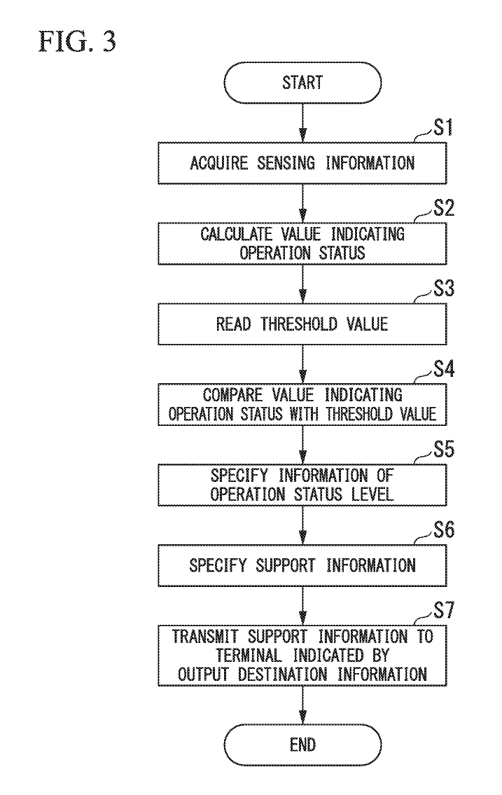

FIG. 3 is a first diagram illustrating a processing flow of the support device 1.

The processing flow of the support device 1 will be described below with reference to FIG. 3.

The operation status calculating unit 13 of the support device 1 acquires sensing information of the management target device 2 via the communication unit 11 (Step S1). When the management target device 2 is a gas turbine, the sensing information includes information indicating whether a compressor constituting the gas turbine is activated and information such as the number of revolutions of a rotor per unit time, an air compressor inlet temperature, an air compressor outlet temperature, an interior pressure, a static intake air pressure, a start signal, and a stop signal when the information is received.

The operation status calculating unit 13 calculates a value indicating the operation status of the management target device 2 by a predetermined calculation formula using the sensing information (Step S2). Various statuses such as a degradation level expressed by an operation efficiency of the management target device 2 and a continuous operating state which are used as the operation status. Details of the calculation of the value indicating the operation status will be described later. The operation status calculating unit 13 outputs the calculated value indicating the operation status to the calculation result comparing unit 14. The operation status calculating unit 13 may also output device identification information (a device ID) of the management target device 2 and status specification information (a status ID) for specifying the calculated operation status to the calculation result comparing unit 14.

The calculation result comparing unit 14 acquires the value of the calculation result, the device ID, and the status ID from the operation status calculating unit 13. The calculation result comparing unit 14 reads one or more threshold values which are determined in advance for the management target device 2 from the database 16 on the basis of the device ID and the status ID (Step S3). In the database 16, one or more threshold values are stored in correlation with the device ID and the status ID. The calculation result comparing unit 14 compares the value indicating the operation status acquired from the operation status calculating unit 13 with the threshold values read from the database 16 (Step S4). The calculation result comparing unit 14 specifies information of the operation status level based on the value indicating the operation status on the basis of the comparison result (Step S5). The calculation result comparing unit 14 outputs the information of the operation status level, the device ID, and the status ID to the support information output unit 15.

For example, when the number of threshold values is one, the calculation result comparing unit 14 outputs any one of two pieces of level information which are specified depending on whether the value indicating the operation status calculated by the operation status calculating unit 13 is equal to or greater than the threshold value or less than the threshold value to the support information output unit 15. Alternatively, when the number of threshold values is two, the calculation result comparing unit 14 outputs any one of three pieces of level information which are specified depending on whether the value indicating the operation status calculated by the operation status calculating unit 13 is equal to or greater than the first threshold value, or less than the first threshold value and equal to or greater than the second threshold value (the first threshold value>the second threshold value), or less than the second threshold value to the support information output unit 15.

The support information output unit 15 specifies support information on the basis of the information of the operation status level, the device ID, and the status ID which are acquired from the calculation result comparing unit 14 (Step S6). For example, the support information output unit 15 reads support information and output destination information which are stored in the database 16 in correlation with three pieces of information of the device ID, the status ID, and the information of the operation status level. The output destination information indicates any one of the first terminal 3 and the second terminal 4. The support information output unit 15 transmits the read support information to the terminal indicated by the read output destination information (Step S7). At least one of the first terminal 3 and the second terminal 4 outputs support information. The support information output unit 15 may determine the support information to be output on the basis of a cost corresponding to the support information and a cost (an upper-limit cost) which the operator operating the management target device 2 can bear. Details thereof will be described later.

Through the above-mentioned processing, the support device 1 can provide support information corresponding to the operation status of the management target device 2 to the manufacturer or the operator. For example, the support device can provide support information for prompting the manufacturer to sell a new part on the basis of the operation status level of the management target device 2. Furthermore, the support device 1 can provide support information for prompting the operator to take an appropriate management measure such as repair or maintenance work on the basis of the operation status level of the management target device 2.

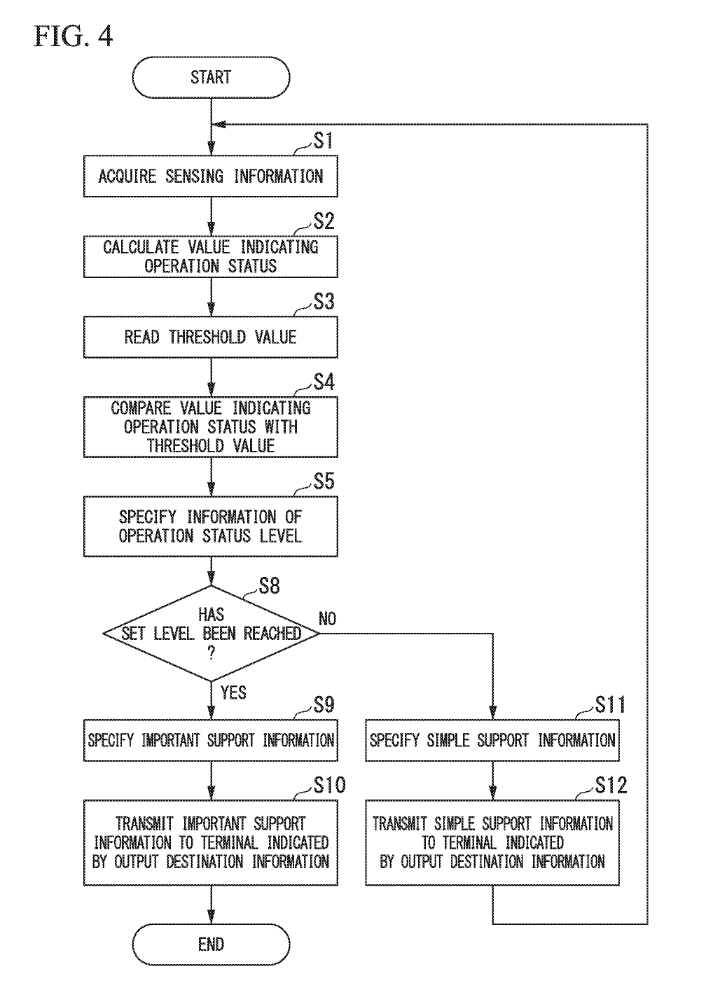

FIG. 4 is a second diagram illustrating the processing flow of the management target operation support device.

The processing flow illustrated in FIG. 4 is the same as the processing flow illustrated in FIG. 3 in Steps S1 to S5. In the processing flow illustrated in FIG. 4, subsequent to Step S5, the support information output unit 15 determines, on the basis of information of the operation status level acquired from the calculation result comparing unit 14, whether the operation status level has reached a set level (Step S8). When the operation status level has reached the set level, it specifies support information when the operation status level reaches the set level (support information which is used for the manufacturer to do business with the operator) (Step S9). The support information output unit 15 transmits the support information read from the database 16 subsequent to Step S9 to the terminal indicated by the output destination information similarly read from the database 16 subsequent to Step S9 (Step S10). The support information output unit 15 specifies simple support information when the operation status level has not reached the set level, when it is determined that the operation status level has not reached the set level on the basis of the information of the operation status level acquired from the calculation result comparing unit 14 (Step S11). The support information output unit 15 transmits the support information read from the database 16 subsequent to Step S11 to the terminal indicated by the output destination information similarly read from the database 16 subsequent to Step S11 (Step S12). The support information output unit 15 may read different output destination information depending on whether the information of the operation status level acquired from the calculation result comparing unit 14 has reached the set level or not and may transmit the support information to the corresponding output destination. For example, when the operation status level (for example, the degradation level) has not reached the set level, the support device 1 transmits the support information to be presented to the operator to the second terminal 4 because improvement can be achieved only by work of the operator side.

For example, when the operation status level (for example, the degradation level) reaches the set level, the support device 1 transmits the support information to be presented to the manufacturer to the first terminal 3 because improvement cannot be achieved only by the work of the operator side.

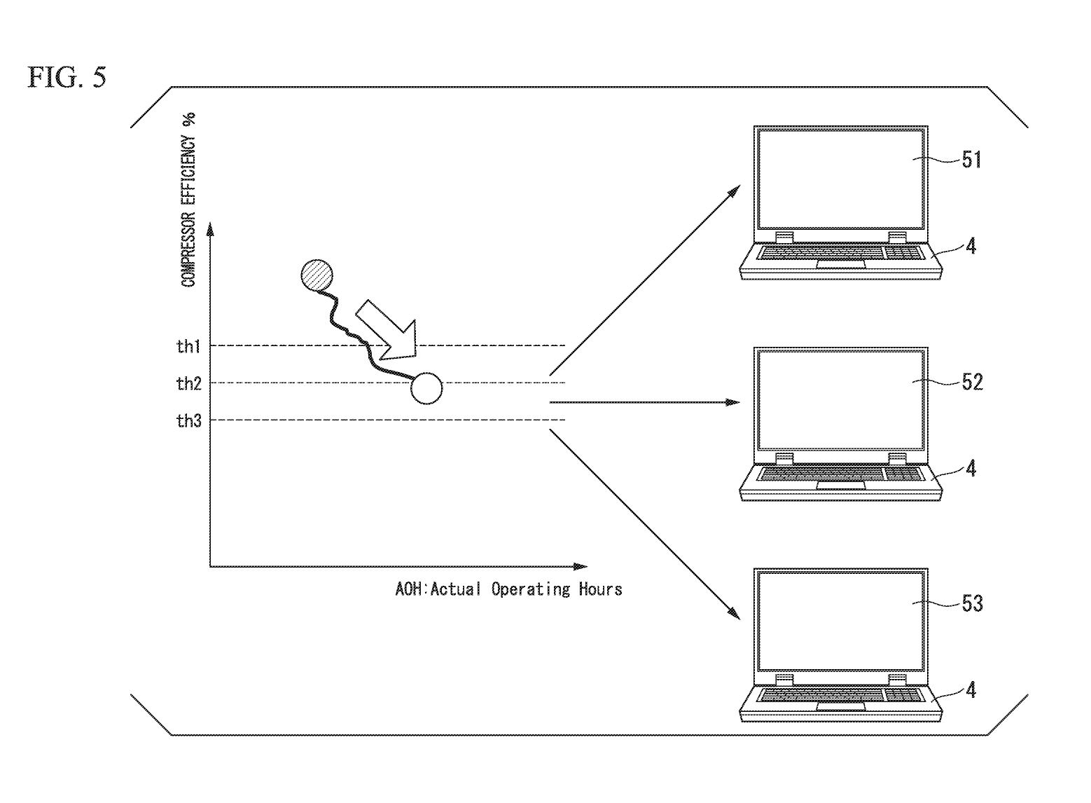

FIG. 5 is a first diagram schematically illustrating the process of specifying support information.

The operation status calculating unit 13 calculates a compressor efficiency on the basis of the sensing information acquired from the management target device 2, for example, in a case where the management target device 2 is a gas turbine. That is, an example of a value indicating the operation status of the management target device 2 is the compressor efficiency of the gas turbine. The calculation result comparing unit 14 reads, on the basis of the device ID and the state ID, a first threshold value th1, a second threshold value th2, and a third threshold value th3 stored in correlation with these IDs from the database 16. The first threshold value th1 is a threshold value for proposing cleaning of blades of the gas turbine when the compressor efficiency is equal to or less than the threshold value. The second threshold value th2 is a threshold value for proposing the operator side employing a first maintenance measure required for recovering the compressor efficiency when the compressor efficiency is equal to or less than the threshold value. The third threshold value ht3 is a threshold value for proposing the operator side employing a second maintenance measure required for recovering the compressor efficiency when the compressor efficiency is equal to or less than the threshold value.

The calculation result comparing unit 14 compares the calculated compressor efficiency with the first threshold value th1, the second threshold value th2, and the third threshold value th3 (where the first threshold value th1 is a value greater than the second threshold value th2 and the second threshold value th2 is a value greater than the third threshold value th3). When “first threshold value th1 compressor efficiency>second threshold value th2” is satisfied, the calculation result comparing unit 14 determines that the operation status level is a level requiring cleaning of blades. In this case, the calculation result comparing unit 14 outputs information (such as a flag) indicating the level requiring cleaning of blades as the information indicating the operation status level, the device ID, and the status ID to the support information output unit 15. The support information output unit 15 reads manual data of a method of cleaning blades, which is stored in the database 16 in correlation with the flag of the information indicating the level requiring cleaning of blades, as the simple support information. The support information output unit 15 reads information (such as an IP address) of an output destination (the second terminal 4) which is stored in the database 16 in correlation with the device ID. The support information output unit 15 transmits the manual data of the method of cleaning blades to the second terminal 4 using the IP address of the second terminal 4. At this time, the support information output unit 15 may transmit a proposal image 51 of the method of cleaning blades as the simple support information to the second terminal 4. The proposal image of the method of cleaning blades is an image for displaying a text for urging performing cleaning of blades on a display screen of the second terminal 4, such as “it is time to perform cleaning of blades.” Hence, the operator can see that it is time to perform cleaning of blades and can perform cleaning of blades using the manual data of the method of cleaning blades. The support information output unit 15 may calculate a time for transmitting the manual data of the method of cleaning blades and the proposal image 51 of the method of cleaning blades to the second terminal 4 and transmit them at that time.

The support information output unit 15 acquires an IP address or an e-mail address of a terminal of a sales representative at the manufacturer (the first terminal 3), which is stored in the database 16 in correlation with the device ID acquired from the calculation result comparing unit 14, company information of the operator, and the like. The support information output unit 15 may transmit information indicating that it is time to perform cleaning of blades of the gas turbine which is operated by the operator and the manual data of the method of cleaning blades to the terminal of the sales representative at the manufacturer. Hence, the sales representative of the manufacturer can perform an operation support action for the operator.

The calculation result comparing unit 14 compares the calculated compressor efficiency with the first threshold value th1, the second threshold value th2, and the third threshold value th3 and determines that it is a level at which it is necessary to propose the operator employing the first maintenance measure when “second threshold value th2 compressor efficiency>third threshold value th3” is satisfied. The calculation result comparing unit 14 outputs the information (such as a flag) for proposing that the operator should employ the first maintenance measure to the support information output unit 15. First maintenance measure information 52 is, for example, a first sales proposal for a part or a product for improving the compressor efficiency to the operator (an example of support information which is used for the manufacturer to do business with the operator).

The calculation result comparing unit 14 compares the calculated compressor efficiency with the first threshold value th1, the second threshold value th2, and the third threshold value th3 and determines that it is a level at which it is necessary to propose the operator employing the second maintenance measure when “third threshold value th3 compressor efficiency” is satisfied. In this case, the calculation result comparing unit 14 outputs information (such as a flag) for proposing the operator employing the second maintenance measure to the support information output unit 15. Second maintenance measure information 53 is, for example, a sales proposal for part or a product for improving the compressor efficiency to the manufacturer (an example of support information which is used for the manufacturer to do business with the operator).

In Step S8, the support information output unit 15 determines whether the calculated compressor efficiency is less than the second threshold value th2 (has reached the set level). When the support information output unit 15 has determined that the calculated compressor efficiency is less than the second threshold value th2, it proceeds to the process of Step S9.

In the process of specifying the support information which is used for the manufacturer to do business with the operator in Step S9, the support information output unit 15 may specify support information to be output on the basis of a cost incurred for the first maintenance measure (or a cost incurred for the second maintenance measure) and a cost which the operator operating the management target can bear. Specifically, when the compressor efficiency satisfies “second threshold value th2 compressor efficiency third threshold value th3,” the support information output unit 15 acquires information (such as a flag) for proposing the operator employing the first maintenance measure (or the second maintenance measure when the compressor efficiency satisfies “third threshold value th3 compressor efficiency”). The support information output unit 15 reads the cost incurred for the first (or second) maintenance measure from the database 16. The support information output unit 15 reads the cost which the operator can bear (for example, a payable amount of money) correlated with the device ID. The support information output unit 15 compares the cost incurred for the first (or second) maintenance measure with the cost which the operator can bear. When it is determined that the cost incurred for the first (or second) maintenance measure is greater than the cost which the operator can bear, the support information output unit 15 reads predetermined support information indicating a cost lower than the cost incurred for the first (or second) maintenance measure and output destination information from the database on the basis of the device ID and the status ID. The support information output unit 15 transmits the support information to the terminal (the second terminal 4 or the first terminal 3) indicated by the output destination information.

In the process of specifying the support information in Step S9, the support information output unit 15 may specify (change) the support information to be output on the basis of a manufacturing time period of a replacement part indicated by the first (or second) maintenance measure and a time period (maintenance time information) required until a next maintenance start date of the operator operating the management target. Specifically, when the compressor efficiency satisfies “second threshold value th2 compressor efficiency third threshold value th3,” the support information output unit 15 acquires information (such as a flag) for proposing the operator employing the first maintenance measure (or the second maintenance measure when the compressor efficiency satisfies “third threshold value th3 compressor efficiency”). When the compressor efficiency satisfies “second threshold value th2 compressor efficiency third threshold value th3,” the support information output unit 15 reads the manufacturing time period of a replacement part indicated by the first maintenance measure (or the second maintenance measure when the compressor efficiency satisfies “third threshold value th3≥compressor efficiency”) from the database 16. The support information output unit 15 reads the time period required until the next maintenance start date of the operator, which is correlated with the device ID. The support information output unit 15 compares the manufacturing time period of a replacement part indicated by the first (or second) maintenance measure with the time period required until the next maintenance start date of the operator. When it is determined that the manufacturing time period of a replacement part indicated by the first (or second) maintenance measure is longer than the time period required until the next maintenance start date of the operator, the support information output unit 15 reads information of the maintenance start date after the next (second maintenance start date) of the operator, the support information 52 (or 53) for the first (or second) maintenance measure, and the output destination information from the database on the basis of the device ID and the status ID. The support information output unit 15 transmits the support information 52 (or 53) to the terminal indicated by the output destination information.

The support information output unit 15 may specify the support information on the basis of a combination of the comparison of the cost incurred for the first (or second) maintenance measure with the cost which the operator operating the management target can bear and the comparison of the manufacturing time period of a replacement part indicated by the first (or second) maintenance measure with the time period required until the next maintenance start date of the operator operating the management target.

When the operation status level of the management target device 2 has not reached the set level (when “compressor efficiency>first threshold value th1” is satisfied), the support information output unit 15 may transmit the support information (simple support information) to be presented to the operator to only the second terminal 4 for operating the management target device. When the operation status level of the management target device 2 has reached the set level (when “second threshold value th2≥compressor efficiency” is satisfied), the support information output unit 15 may transmit the support information which is used for the manufacturer to do business with the operator to the first terminal 3 for manufacturing the management target device.

An example in which the compressor efficiency ηc [ISO] of the gas turbine is calculated will be described below.

The operation status calculating unit 13 acquires an air compressor inlet temperature T1c [° C.], an air compressor outlet temperature T2c [° C.], an interior pressure Pcs [kPa], and a static intake air pressure P1c [kPa] which are the sensing information from the gas turbine connected via a communication network. The operation status calculating unit 13 reads an intake air temperature correction factor C1, an atmospheric pressure correction factor C2, and a specific heat ratio of air k from the database 16. The operation status calculating unit 13 calculates the compressor efficiency of the gas turbine using the following expression.

$${η}_{C [ ISO ]} = \frac{( {T}_{1 C} + 273 )}{{T}_{2 C} - {T}_{1 C}} \{ {( \frac{{P}_{CS}}{{P}_{1 C}} )}^{\frac{κ - 1}{κ}} - 1 \} \times \frac{1}{{C}_{1} \times {C}_{2}} \qquad [ Expression 1 ]$$

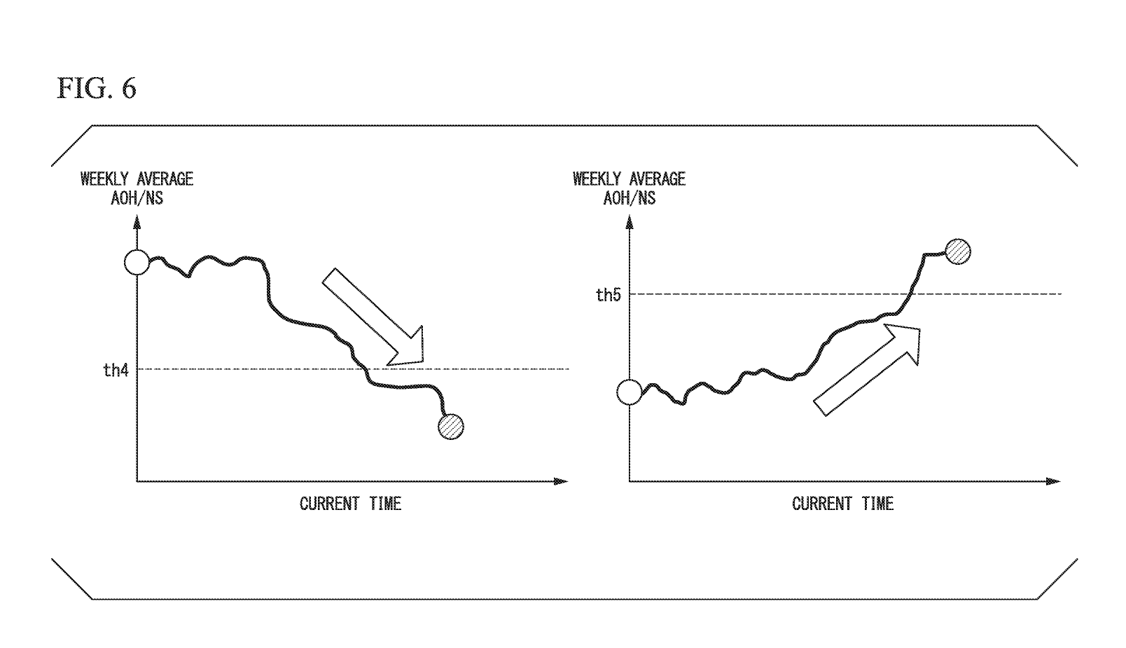

FIG. 6 is a second diagram schematically illustrating the process of specifying the support information.

The operation status calculating unit 13 calculates a value for determining a situation in which the gas turbine stops activation thereof (hereinafter referred to as a determination value) on the basis of the sensing information acquired from the management target device 2. The determination value denotes “the time in which the gas turbine is operated at the rated rotational speed (AOH (Actual Operating Hours))/the number of start and stops (NS) of the gas turbine.” The number of start and stops NS of the gas turbine is a value when one start and one stop is counted to be one. The calculation result comparing unit 14 determines whether the determination value calculated in a predetermined period is equal to or less than a threshold value th4 for determining an increase in the set number of start and stops or is equal to or greater than a threshold value th5 for determining an increase in the set operating time. The determination value may be an average value in the predetermined period.

The threshold value th4 for determining an increase in the number of start and stops is a threshold value for proposing the operator employing a maintenance measure suitable for a variation in the operation status indicated by the increase in the number of start and stops because the number of start and stops has increased.

The threshold value th5 for determining an increase in the operating time is a threshold value for proposing the operator employing a maintenance measure suitable for a variation in the operation status indicated by the increase in the operating time because the number of start and stops has decreased.

The threshold value th4 for determining an increase in the number of start and stops may be a value such as 1/x times a value calculated in a previous predetermined period (where x is an arbitrary value).

The threshold value th5 for determining an increase in the operating time may be a value such as y times a value calculated in a previous predetermined period (where y is an arbitrary value).

The calculation result comparing unit 14 compares the determination value calculated in the predetermined period with the threshold value th4 and the threshold value th5. The calculation result comparing unit 14 determines that it has reached a level at which a maintenance measure is necessary due to the increase in the number of start and stops when the determination value is equal to or less than the threshold value th4. The calculation result comparing unit 14 outputs information (such as a flag) indicating that it has reached the level at which a maintenance measure is necessary to the support information output unit 15. The support information output unit 15 reads manual data which is used for a measure when the number of start and stops has increased and which is stored in the database 16 in correlation with the flag of the information indicating that it has reached the level at which a maintenance measure is necessary due to the increase in the number of start and stops. The support information output unit 15 reads information (such as an IP address) of the output destination information (the second terminal 4) stored in the database 16 in correlation with the device ID. The support information output unit 15 transmits the manual data which is used for a measure when the number of start and stops has increased as simple support information to the second terminal 4 using the IP address of the second terminal 4.

At this time, the support information output unit 15 may transmit an image which is used for the measure when the number of start and stops has increased as the support information to the second terminal 4. The image which is used for the measure when the number of start and stops has increased is, for example, an image for displaying text for prompting the operator to take the measure when the number of start and stops has increased on a display screen of the second terminal 4. Hence, the operator can see that it is time to take the measure when the number of start and stops has increased and can take the measure with reference to the manual data which is used for the measure when the number of start and stops has increased. The support information output unit 15 may acquire an IP address or an e-mail address of a terminal (the first terminal 3) of a sales representative of the manufacturer and company information of the operator, and the like which are stored in the database 16 in correlation with the device ID acquired from the calculation result comparing unit 14, and transmit information indicating that the number of start and stops of the gas turbine operated by the operator has an increasing trend and the manual data associated with the increase in the number of start and stops to the terminal of the sales representative of the manufacturer. Hence, the sales representative of the manufacturer side can perform an operation support action for the operator.

The calculation result comparing unit 14 determines that it has reached a level at which a maintenance measure due to an increase in the operating time is necessary when the determination value is equal to or less than the threshold value th5, and outputs information (such as a flag) indicating the level to the support information output unit 15. The support information output unit 15 reads manual data for a measure when the operating time has increased which is stored in the database 16 in correlation with the flag of the information indicating the level at which a maintenance measure due to an increase in the operating time is necessary. The support information output unit 15 reads information (such as an IP address) of the output destination information (the second terminal 4) stored in the database 16 in correlation with the device ID. The support information output unit 15 transmits the corresponding manual data for a measure when the operating time has increased as simple support information to the second terminal 4 using the IP address of the second terminal 4.

At this time, the support information output unit 15 may transmit an image which is used for a measure when the operating time has increased as the support information to the second terminal 4. The image which is used for the measure when the operating time has increased is, for example, an image for displaying text for prompting the operator to take the measure when the operating time has increased on a display screen of the second terminal 4. Hence, the operator can see that it is time to take the measure when the operating time has increased. The operator can take the measure with reference to the corresponding manual data which is used when the operating time has increased. The support information output unit 15 acquires an IP address or an e-mail address of a terminal (the first terminal 3) of a sales representative of the manufacturer and company information of the operator, and the like which are stored in the database 16 in correlation with the device ID acquired from the calculation result comparing unit 14. The support information output unit 15 may transmit, with respect to the terminal of the sales representative of the manufacturer, information indicating that the operating time of the gas turbine operated by the operator has an increasing trend and the manual data used when the operating time has increased to the first terminal 3. Hence, the sales representative of the manufacturer side can perform an operation support action for the operator.

In Step S8 described above, the support information output unit 15 may determine whether the determination value calculated in the predetermined period such as a week is equal to or less than a threshold value th4-2 (or a threshold value th4-3) of three different threshold values th4-1, th4-2, and th4-3 for determining the increase in the number of start and stops (whether it has reached the set level). The threshold value th4-1 is a value greater than the threshold value th4-2. The threshold value th4-2 is a value greater than the threshold value th4-3. When the support information output unit 15 has determined that the calculated determination value is equal to or less than the threshold value th4-2 (it has reached the set level) (or when the determination value is equal to or less than the threshold value th4-3), it proceeds to the process of Step S9. In the process of specifying the support information which is used for the manufacturer to do business with the operator in Step S9, the support information output unit 15 may specify the support information to be output on the basis of the cost incurred for the maintenance measure when the determination value is equal to or less than the threshold value th4-2 (or the threshold value th4-3) (when the number of start and stops has increased) and the cost which the operator operating the management target can bear.

Specifically, when the determination value is equal to or less than the threshold value th4-2 (or the threshold value th4-3) (when the number of start and stops has increased), the support information output unit 15 acquires information (such as a flag) indicating the level at which a maintenance measure is necessary. Then, the support information output unit 15 reads the cost incurred for the maintenance measure when the determination value is equal to or less than the threshold value th4-2 (or the threshold value th4-3) (when the number of start and stops has increased) from the database 16. In addition, the support information output unit 15 reads the cost (for example, an amount of payable money) which the operator can bear correlated with the device ID. The support information output unit 15 compares the cost incurred for the maintenance measure when the determination value is equal to or less than the threshold value th4-2 (or the threshold value th4-3) (when the number of start and stops has increased) with the cost which the operator can bear. A case in which the support information output unit 15 determines that the cost incurred for the maintenance measure due to the increase in the number of start and stops, which corresponds to the threshold value th4-2 (or the threshold value th4-3) is greater than the cost which the operator can bear will be described below. In this case, the support information output unit 15 reads support information indicating a predetermined maintenance measure indicating a cost lower than that of the maintenance measure when the determination value is equal to or less than the threshold value th4-2 (or the threshold value th4-3) (when the number of start and stops has increased) and the output destination information (the IP address of the second terminal 4 or the first terminal 3) from the database on the basis of the device ID and the status ID. Then, the support information output unit 15 transmits the support information which is used for the manufacturer to do business with the operator to the terminal (the second terminal 4 or the first terminal 3) indicated by the output destination information.

In the process of specifying the support information which is used for the manufacturer to do business with the operator in Step S9, the support information output unit 15 reads the manufacturing time period of a replacement part for the maintenance measure when the determination value is equal to or less than the threshold value th4-2 (or the threshold value th4-3) (when the number of start and stops has increased) and the period required up to the next maintenance start date of the operator operating the management target. The support information output unit 15 may specify the support information to be output on the basis of the respective read periods. Specifically, when the determination value is equal to or less than the threshold value th4-2 (or the threshold value th4-3), the support information output unit 15 acquires information (such as a flag) which is used to suggest to the operator employment of the maintenance measure in that case. Then, the support information output unit 15 reads the manufacturing time period of a replacement part for the maintenance measure when the determination value is equal to or less than the threshold value th4-2 (or the threshold value th4-3) from the database 16. The support information output unit 15 reads the period required up to the next maintenance start date of the operator correlated with the device ID. The support information output unit 15 compares the manufacturing time period of a replacement part for the maintenance measure when the determination value is equal to or less than the threshold value th4-2 (or the threshold value th4-3) with the period required up to the next maintenance start date of the operator. When it is determined that the manufacturing time period of a replacement part for the maintenance measure when the determination value is equal to or less than the threshold value th4-2 (or the threshold value th4-3) is longer than the period required up to the next maintenance start date of the operator, the support information output unit 15 reads information of the maintenance start date after the next (second maintenance start date) of the operator, support information which is used for the manufacturer to do business with the operator based on the maintenance measure when the determination value is equal to or less than the threshold value th4-2 (or the threshold value th4-3) (when the number of start and stops has increased), and the output destination information from the database on the basis of the device ID and the status ID. Then, the support information output unit 15 transmits the support information which is used for the manufacturer to do business with the operator to the terminal (the first terminal 3) indicated by the output destination information.

The support information output unit 15 may specify the support information on the basis of a combination of both comparison results of comparison of the cost incurred for the maintenance measure with the cost which the operator operating the management target device can bear and comparison of the manufacturing time period of the replacement part indicated by the maintenance measure with the period required up to a next maintenance start date of the operator operating the management target device.

The above-mentioned support device 1 has a computer system therein. The above-mentioned respective processes are stored in the form of a program in a computer-readable recording medium and the processes are performed by causing the computer system to read and execute the program. Here, examples of the computer-readable recording medium include a magnetic disk, a magneto-optical disk, a CD-ROM, a DVD-ROM, and a semiconductor memory. The computer program may be transmitted to a computer via a communication line and the computer receiving the computer program may execute the computer program.

The program may be a program for realizing a part of the above-mentioned functions. The program may be a so-called differential file (a differential program) which can realize the above-mentioned functions in combination with another program stored in advance in the computer system.

### INDUSTRIAL APPLICABILITY

The present invention may be applied to a management target operation support device, a management target operation support method, and a program therefor.

### REFERENCE SYMBOLS

1 Management target operation support device (support device)
2 Management target device
3 Manufacturer-side terminal (first terminal)
4 Operator-side terminal (second terminal)
11 Communication unit
12 Control unit
13 Operation status calculating unit
14 Calculation result comparing unit
15 Support information output unit
16 Database

1-6. (canceled)

7. A management target operation support device comprising:
an operation status calculating unit configured to calculate an operation status of a management target device based on acquired sensing information of the management target device;
a calculation result comparing unit configured to compare an operation status level indicated by the calculation result of the operation status with one or more threshold values for distinguishing the operation status level; and
a support information output unit configured to output support information of the management target device corresponding to the operation status level based on the comparison result of the operation status level with the one or more threshold values, status specification information for specifying the operation status, and device identification information of the management target device.

8. The management target operation support device according to claim 7, wherein the support information output unit determines the support information to be output based on a cost corresponding to the support information and an affordable cost of an operator who operates the management target device.

9. The management target operation support device according to claim 7, wherein when the support information is information for prompting replacement of a part of the management target device, the support information output unit changes the support information to be output based on a manufacturing time period of the part and maintenance time information determined in advance for the management target device.

10. The management target operation support device according to claim 7,
wherein the support information output unit transmits the support information to a terminal of an operator who operates the management target device when the level indicates a set low level, and
the support information output unit transmits the support information to a terminal of a manufacturer who has manufactured the management target device when the operation status level is not the set low level.

11. A management target operation support method comprising:
calculating an operation status of a management target device based on acquired sensing information of the management target device;
comparing an operation status level indicated by the calculation result of the operation status with one or more threshold values for distinguishing the operation status level; and
outputting support information of the management target device corresponding to the operation status level based on the comparison result of the operation status level with the one or more threshold values, status specification information for specifying the operation status, and device identification information of the management target device.

12. A program that causes a computer of a management target operation support device to execute:
calculating an operation status of a management target device based on acquired sensing information of the management target device;
comparing an operation status level indicated by the calculation result of the operation status with one or more threshold values for distinguishing the operation status level; and
outputting support information of the management target device corresponding to the operation status level based on the comparison result of the operation status level with the one or more threshold values, status specification information for specifying the operation status, and device identification information of the management target device.
